(19) United States
(12) Patent Application Publication
(10) Pub. No.: US 2022/0012525 A1
(43) Pub. Date: Jan. 13, 2022

(54) HISTOGRAM GENERATION

(71) Applicant: International Business Machines Corporation, Armonk, NY (US)

(72) Inventors: Xing Wei, Xian (CN); Xiao Bin Sun, Xian (CN); Chun Lei Xu, Xian (CN); Zhe Shao, Xian (CN); Liu Zhen Duo, Xian (CN); Dong Hai Yu, Xian (CN)

(21) Appl. No.: 16/926,074

(22) Filed: Jul. 10, 2020

(51) Int. Cl. G06K 9/62

(52) U.S. Cl. CPC G06K 9/6212; G06K 9/6215; G06K 9/6223

(57) ABSTRACT

Embodiments of the present invention relate to a method, system and computer program product for histogram generation. In an embodiment, a first set of bins are acquired for a histogram based on the plurality of data points. In response to receiving a data point, a bin closest to the data point is determined from the first set of bins. In response to a distance between the data point and the bin not exceeding a threshold, the data point is merged into a target bin of the first set of bins, where the width of the target bin after merging the data point is closest to an average width of the first set of bins before the merging. In other embodiments, a system and a computer program product are disclosed.

### BACKGROUND

The present disclosure relates to data processing, and more specifically, to a method, system, and computer program product for histogram generation.

Histogram is a common data analyzing technology, which is typically used to approximate data distributions. A histogram includes a plurality of bins, each bin having a width representing a data range and a height indicating a count of data points falling within the data range. In a cloud computing environment or a streaming environment, data points can be scanned only once. However, it is difficult to get data ranges and their respective counts of data points through one data scan.

### SUMMARY

According to one embodiment of the present disclosure, there is provided a computer-implemented method. The method comprises acquiring a first set of bins for a histogram. The first set of bins is generated based on a plurality of data points and comprises a predetermined number of bins. The method further comprises, in response to receiving a data point, determining a bin closest to the data point from the first set of bins. The method further comprises, in response to a distance between the data point and the bin not exceeding a threshold, merging the data point into a target bin comprised in the first set of bins, wherein a width of the target bin after merging the data point is closest to an average width of the first set of bins before the merging.

According to another embodiment of the present disclosure, there is provided a system. The system comprises a processing unit and a memory coupled to the processing unit. The memory stores instructions that, when executed by the processing unit, perform actions comprising: acquiring a first set of bins for a histogram, wherein the first set of bins is generated based on a plurality of data points and comprises a predetermined number of bins; in response to receiving a data point, determining a bin closest to the data point from the first set of bins; and in response to a distance between the data point and the bin not exceeding a threshold, merging the data point into a target bin comprised in the first set of bins, wherein a width of the target bin after merging the data point is closest to an average width of the first set of bins before the merging.

According to yet another embodiment of the present disclosure, there is provided a computer program product. The computer program product is tangibly stored on non-transient machine-readable medium and comprises machine-executable instructions. The machine-executable instructions, when executed on a device, cause the device to perform actions comprising: acquiring a first set of bins for a histogram, wherein the first set of bins is generated based on a plurality of data points and comprises a predetermined number of bins; in response to receiving a data point, determining a bin closest to the data point from the first set of bins; and in response to a distance between the data point and the bin not exceeding a threshold, merging the data point into a target bin comprised in the first set of bins, wherein a width of the target bin after merging the data point is closest to an average width of the first set of bins before the merging.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 depicts a system for histogram generation according to an embodiment of the present invention.

FIG. 5 depicts a flowchart of an example method for histogram generation according to an embodiment of the present invention.

FIG. 6A depicts an example of generating a first set of bins for a histogram according to an embodiment of the present invention.

FIGS. 6B-6D depict examples of merging a data point into a target bin according to an embodiment of the present invention.

FIGS. 7A-7C depict an example of adjusting bins of a histogram according to an embodiment of the present invention.

FIGS. 8A-8B depict another example of adjusting bins of a histogram according to an embodiment of the present invention.

### DETAILED DESCRIPTION

Histogram is a common data analyzing technology that is typically used to approximate data distributions. A histogram includes a plurality of bins, each bin having a width representing a data range and a height indicating a count of data points falling within the data range. Traditionally, in order to generate a histogram to reflect a data distribution of a plurality of data points, the plurality of data points need to be scanned twice. Data ranges can be obtained through a first data scan, while respective counts of data points falling within the data ranges can be obtained through a second data scan.

However, in a cloud computing environment, a number of data points may be requested from remote nodes via a network (i.e., the Internet). Due to network latency, the transmission speed of the data points is usually lower than the processing speed of the data points to reduce the processing efficiency. Thus, it would be desirable to generate a histogram by requesting the data points from the remote nodes only once. In addition, in a streaming environment, the streaming data points may be generated in real time and transmitted continuously. In order to present the distribution of the streaming data points by means of a graphical way to users in real time, it would be desirable to generate a histogram by scanning the streaming data points only once.

Usually, it is difficult to get data ranges and their respective counts of data points through one data scan, especially in a cloud computing environment or a streaming environment. Some traditional solutions propose to merge and count cloudy or streaming data points to generate an approximate histogram through one data scan. However, these solutions cannot get accurate data ranges, and thus the generated histogram cannot reflect an accurate data distribution of the cloudy or streaming data points. In order to at least partially solve the above and other potential problems, especially in a cloud computing environment or a streaming environment, embodiments of the present invention provide a solution for histogram generation.

According to embodiments of the present invention, especially in a cloud computing environment or a streaming environment, a first set of bins are generated for a histogram based on the plurality of data points. The first set of bins comprises a predetermined number of bins. In response to receiving a data point, a bin closest to the data point is determined from the first set of bins. In response to a distance between the data point and the bin not exceeding a threshold, the data point is merged into a target bin comprised in the first set of bins, where a width of the target bin after merging the data point is closest to an average width of the first set of bins before the merging. In response to the distance between the data point and the bin exceeding the threshold, two closest bins comprised in the first set of bins are merged into one bin and a new bin is generated based on the data point.

As such, through only one data scan, an accurate histogram can be generated to reflect an accurate data distribution of the data points. Therefore, the present invention can be applicable to the cloud computing environment or the streaming environment, so as to present the distribution of the data points in a graphical way to the users.

Some embodiments will be described in more detail with reference to the accompanying drawings, in which the embodiments of the present invention have been illustrated. However, the present invention can be implemented in various manners, and thus should not be construed to be limited to the embodiments disclosed herein.

It is to be understood that although this invention includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (iaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

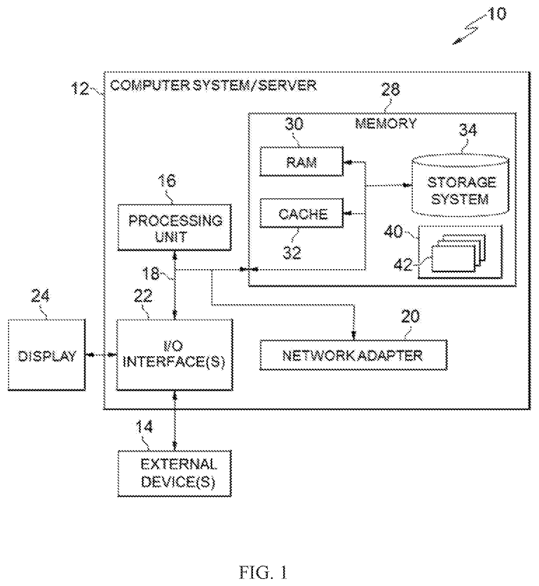

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.: one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

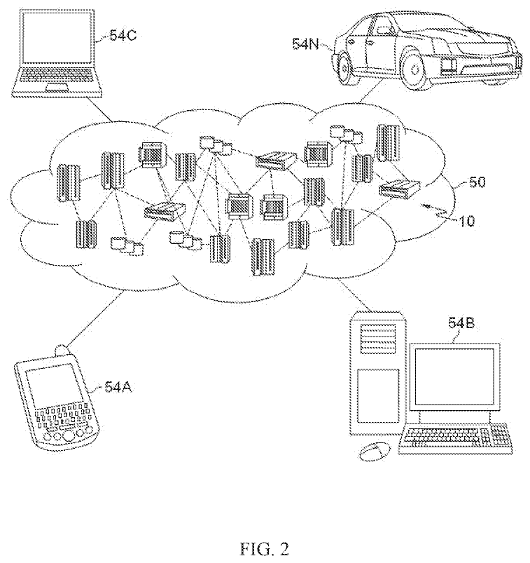

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private. Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

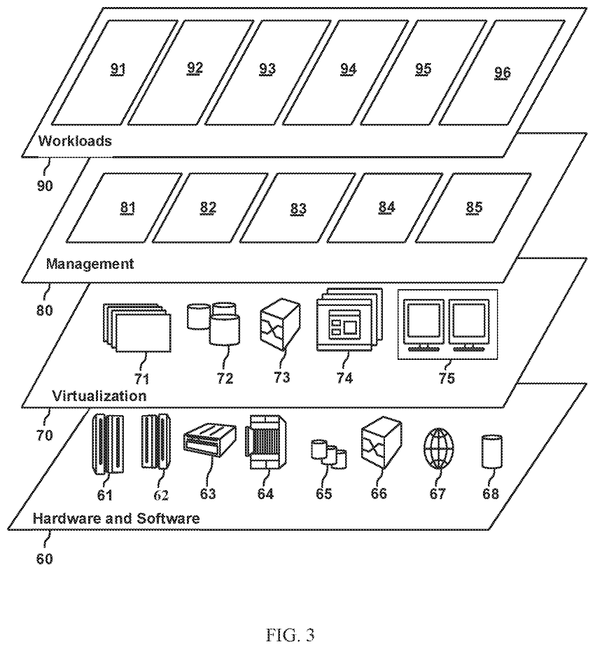

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72: virtual networks 73, including virtual private networks; virtual applications and operating systems 74: and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

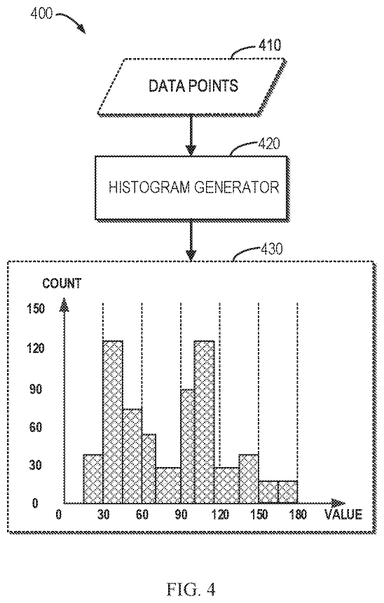

Workloads layer 90 provides examples of functionality for which the cloud computing environment may be utilized. Examples of workloads and functions which may be provided from this layer include: mapping and navigation 91: software development and lifecycle management 92; virtual classroom education delivery 93; data analytics processing 94; transaction processing 95; and histogram generation 96. Hereinafter, reference will be made to FIG. 4-8 to describe details of the histogram generation 96.

With reference now to FIG. 4, a system 400 for histogram generation in which embodiments of the present invention can be implemented is shown. It is to be understood that the structure and functionality of the system 400 are described only for the purpose of illustration without suggesting any limitations as to the scope of the present invention. The embodiments of the present invention can be embodied with a different structure and/or functionality. For example, at least part or all of the system 400 may be implemented by computer system/server 12 of FIG. 1.

As shown in FIG. 4, the system 400 comprises a histogram generator 420. For example, the histogram generator 420 may be implemented by computer system/server 12 of FIG. 1. The histogram generator 420 may receive a data stream comprising a number of data points 410 that are continuously transmitted to the histogram generator 420 via a network, especially in a cloud computing environment or a streaming environment. The histogram generator 420 may generate a histogram 430 based on values of the data points 410 to present the data points 410 in real time by means of a visual method. The histogram 430 may include a plurality of bins, each of which has a width representing a range of values and a height indicating a count of data points falling within the range of values. The histogram 430 can reflect a data distribution of the data points 410.

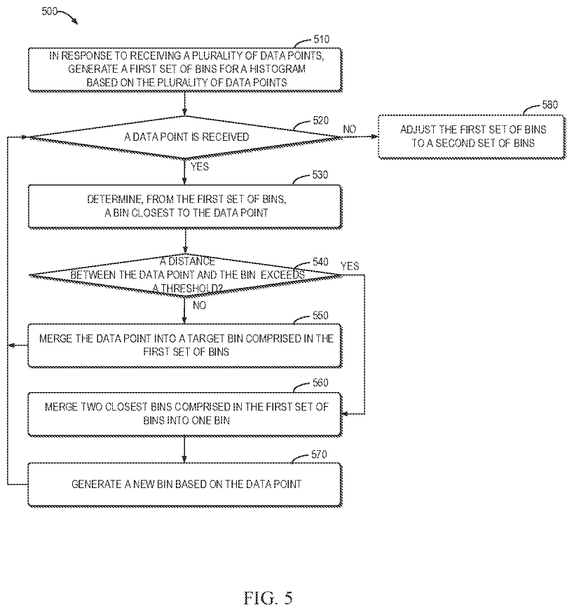

FIG. 5 depicts a flowchart of an example method 500 for histogram generation according to an embodiment of the present invention. The method 500 may be implemented by the histogram generator 420 as shown in FIG. 4. It is to be understood that the method 500 may also comprise additional blocks (not shown) and/or may omit the illustrated blocks. The scope of the present invention described herein is not limited in this aspect.

At block 510, the histogram generator 420 acquires, for example, a first set of bins for a histogram. The first set of bins is generated based on a plurality of data points or using an existing set of bins as the first set of bins.

In some embodiments, the histogram generator 420 may include a buffer that can store at most a predetermined number of bins. Initially, the buffer is empty. If the histogram generator 420 receives a first data point, the histogram generator 420 may generate a first bin based on the first data point. For example, upper and lower bounds of the first bin can be determined as a value of the first data point. Thus, the first bin has a width of 0 and a height of 1. The histogram generator 420 may store the first bin in the buffer, for example, by storing the upper bound, the lower bound, and the height of the first bin in the buffer.

In some embodiments, if the histogram generator 420 receives a second data point having a same value as one of existing data points comprised in the first set of bins, the histogram generator 420 may merge the second data point into a respective bin representing the one of the existing data points. Thus, after merging the second data point, a width of the respective bin is still 0 and a height of the respective bin is incremented by 1. For example, the histogram generator 420 may update the height of the respective bin in the buffer.

In some embodiments, if the histogram generator 420 receives a third data point having a different value from any existing data point comprised in the first set of bins and if the buffer is not full, the histogram generator 420 may generate a second bin based on the third data point. For example, upper and lower bounds of the second bin can be determined as a value of the third data point. Thus, the second bin has a width of 0 and a height of 1. The histogram generator 420 may store the second bin in the buffer, for example, by storing the upper bound, the lower bound, and the height of the second bin in the buffer.

In some embodiments, if the buffer is full, the histogram generator 420 can determine that the first set of bins are generated.

In this way, the histogram generator 420 can generate the first set of bins based on the received data points. The first set of bins comprises the predetermined number of bins. Each of the bins may represent at least one data point of the plurality of data points, and have a width characterized by upper and lower bounds of values of the at least one data point and a height indicating the number of the at least one data point. For example, the width of each of the first set of bins may be 0.

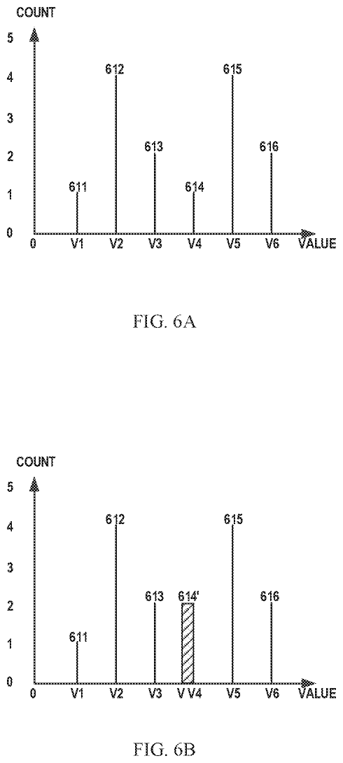

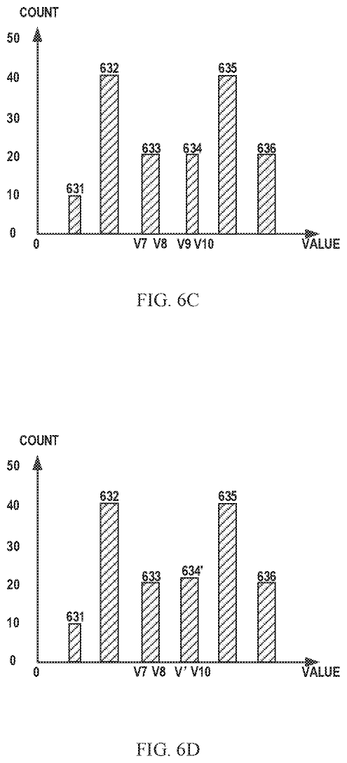

FIG. 6A depicts a schematic diagram for generating a first set of bins for a histogram according to an embodiment of the present invention. FIG. 6A shows six bins 611, 612 . . . 616. For example, the upper and lower bounds of the bin 611 are V1. The upper and lower bounds of the bin 612 are V2. The upper and lower bounds of the bin 613 are V3. The upper and lower bounds of the bin 614 are V4. The upper and lower bounds of the bin 615 are V5. The upper and lower bounds of the bin 616 are V6. That is, each of the bins 611, 612 . . . 616 has a width of 0.

With reference back to FIG. 5, after the first set of bins are generated, at block 520, the histogram generator 420 determines if a data point is received. If it is determined a data point is received, the method 500 proceeds to block 530.

At block 530, the histogram generator 420 determines, from the first set of bins, a bin closest to the data point. For example, a distance between the data point and a bin can be determined as a smaller one of the following: a first difference between the value of the data point and the upper bound of the bin and a second difference between the value of the data point and the lower bound of the bin. The histogram generator 420 may determine, from the first set of bins, the bin with the shortest distance from the data point.

At block 540, the histogram generator 420 determines if the distance between the data point and the bin exceeds a threshold. If it is determined that the distance does not exceed the threshold, the method 500 proceeds to block 550.

At block 550, the histogram generator 420 merges the data point into a target bin comprised in the first set of bins, where the width of the target bin after merging the data point is closest to an average width of the first set of bins before the merging. Then, the method 500 goes back to block 520.

In some embodiments, the histogram generator 420 may determine the target bin from the first set of bins, where the width of the target bin after merging the data point is closest to an average width of the first set of bins before merging the data point. In response to the target bin being determined, the histogram generator 420 may merge the data point into the target bin.

In some embodiment, if a value of the data point falls between the upper and lower bounds of the target bin, the histogram generator 420 may merge the data point into the target bin by incrementing the height of the target bin. That is, the upper bound, the lower bound, and the width of the target bin do not need to be updated.

Alternatively, if the value of the data point is below the lower bound of the target bin, the histogram generator 420 may determine the value of the data point as a new lower bound of the target bin. The histogram generator 420 may update the width of the target bin based on the original upper bound and the new lower bound of the target bin, and then merge the data point into the target bin by incrementing the height of the target bin.

Alternatively, if the value of the data point is above the upper bound of the target bin, the histogram generator 420 may determine the value of the data point as a new upper bound of the target bin. The histogram generator 420 may update the width of the target bin based on the new upper bound and the original lower bound of the target bin, and then merge the data point into the target bin by incrementing the height of the target bin.

FIG. 6B depicts an example of merging a data point into a target bin according to an embodiment of the present invention. As shown in FIG. 6B, for example, a data point having a value of V is received after the bins 611, 612 . . . 616 are generated, where V3<V<V4 and (V−V3)>(V4−V). That is, the data point is closest to the bin 614. In this event, the bin 614 can be determined as the target bin. As shown in FIG. 6B, since the value of the data point is below the lower bound of the bin 614, the value of the data point, that is, V, can be determined as a new lower bound of the bin 614. Thus, the width of the bin 614 can be updated to (V4−V) and the height of the bin 614 can be incremented by 1, as denoted by 614′ in FIG. 6B.

FIGS. 6C and 6D depict another example of merging a data point into a target bin according to an embodiment of the present invention. For example, after several merges, the bins 611, 612 . . . 616 as shown in FIG. 6A have been updated to bins 631, 632 . . . 636 as shown in FIG. 6C, where the upper and lower bounds of each of the bins 631, 632 . . . 636 are different. For example, lower and upper bounds of the bin 633 are V7 and V8, where V7<V8. The lower and upper bounds of the bin 634 are V9 and V10, where V8<V9<V10. At this time, a new data point having a value of V′ is received, where V8<V′<V9 and (V′−V8)>(V9−V′). If the new data point is merged to the bin 634, the width of the bin 634 will be updated to (V10−V′). If the new data point is merged to the bin 633, the width of the bin 633 will be updated to (V′−V7). Since (V10−V′) is closer to an average width of the bins 631, 632 . . . 636 than (V′−V7), the bin 634 can be determined as the target bin. Thus, the new data point can be merged into the bin 634. For example, the lower bound of the bin 634 can be updated to V′. The width of the bin 634 can be updated to (V10−V′) and the height of the bin 634 can be incremented by 1, as denoted by 634′ in FIG. 6D.

If the histogram generator 420 determines, at block 540, that the distance between the data point and the bin exceeds the threshold, the method 500 proceeds to block 560.

At block 560, the histogram generator 420 merges two closest bins comprised in the first set of bins into one bin. For example, a distance between any two bins can be determined as a difference between the lower bound of one bin and the upper bound of the other bin, where the lower bound of the one bin exceeds the upper bound of the other bin. Accordingly, two bins having the shortest distance among the first set of bins can be determined as the two closet bins. For example, the two closest bins may include a third bin and a fourth bin, where the upper bound of the third bin is lower than the lower bound of the fourth bin. The lower bound of the merged bin can be determined as the lower bound of the third bin and the upper bound of the merged bin can be determined as the upper bound of the fourth bin. The height of the merged bin can be determined as a sum of heights of the third and fourth bins. The histogram generator 420 may replace the third and fourth bins with the merged bin in the buffer.

At block 570, the histogram generator 420 generates a new bin based on the data point. For example, upper and lower bounds of the new bin can be determined as a value of the data point. Thus, the new bin has a width of 0 and a height of 1. The histogram generator 420 may store the new bin in the buffer, for example, by storing the upper bound, the lower bound and the height of the new bin in the buffer. Then, the method 500 goes back to block 520.

In this way, the first set of bins can be continuously updated, until no data point can be received. Thus, an accurate histogram can be generated to reflect an accurate data distribution of the received data points through one data scan.

It can be seen that, although the generated histogram is accurate, the bins in the generated histogram may not have a same width. In some cases, it would be desirable to make widths of the bins in the histogram as even as possible, so as to reflect densities of data points falling within different ranges.

With reference back to FIG. 5, in some embodiments, if it is determined that no data point can be received at block 520, the method 500 may proceed to block 580, where the histogram generator 420 adjusts the first set of bins to a second set of bins, such that widths of the second set of bins are more even than widths of the first set of bins.

In some embodiments, the number of the second set of bins may be the same as the number of the first set of bins. Alternatively, the number of the second set of bins may be different from the number of the first set of bins. Many policies may be applicable to the adjusting, some of which will be described in the following. It is to be understood that this is merely for the purpose of illustration, without suggesting any limitation as to the scope of the present invention. In other embodiments, the adjusting can be performed based on a policy different from those as described below.

In some embodiments, the histogram generator 420 may adjust the first set of bins to the second set of bins with a same width, such that an error introduced by the adjusting with respect to a distribution of the received data points is minimized.

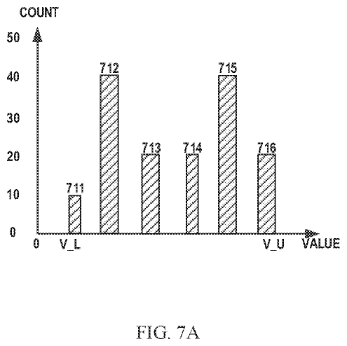

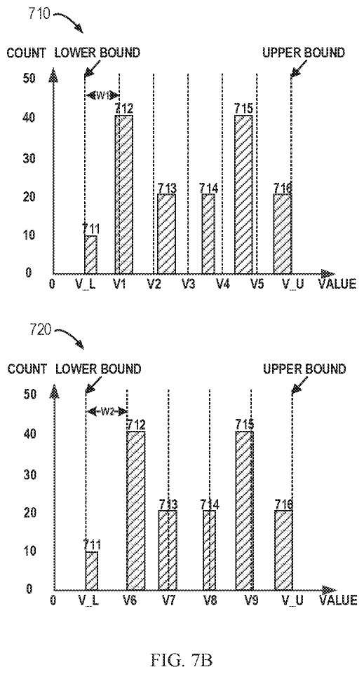

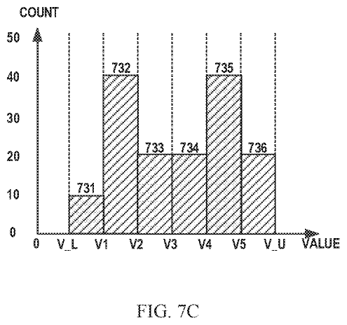

FIGS. 7A-7C depict an example of adjusting bins of a histogram according to an embodiment of the present invention. FIG. 7A shows a histogram comprising 6 bins 711, 712 . . . 716. FIG. 7B shows two policies 710 and 720 for adjusting the bins 711, 712 . . . 716 as shown in FIG. 7A to a group of bins of a same width. As shown by the policies 710 and 720, for example, the lower bound of the bin 711 is V_L, which is the minimum value of the bounds in the set of bins and can be determined as the lower bound of the group of bins. The upper bound of the bin 716 is V_U, which is the maximum value of the bounds in the set of bins and can be determined as the upper bound of the group of bins.

According to the policy 710, the range between V_L and V_U is divided into six sub-ranges, each of which has a width W1. The six sub-ranges may correspond to the group of bins to which the bins 711, 712 . . . 716 can be adjusted. It can be seen that the bin 712 is overlapped with two sub-ranges [V_L, V1] and (V1, V2]. That means values of some data points in the bin 712 are greater than V1, while values of remaining data points in the bin 712 are less than V1. Regardless of whether the bin 712 is adjusted to the sub-range [V_L, V1] or (V1, V2], an error will be introduced.

According to the policy 720, the range between V_L and V_U is divided into five sub-ranges, each of which has a width W2. The five sub-ranges may correspond to the group of bins to which the bins 711, 712 . . . 716 can be adjusted. It can be seen that each of the bins 713, 714 and 715 is overlapped with two sub-ranges. For example, regarding the bin 713, regardless of whether the bin 713 is adjusted to the sub-range V6, V7] or (V7, V8], an error will be introduced.

In some embodiments, the histogram generator 420 may calculate respective errors introduced by different policies. For example, in the example as shown in FIG. 7B, the error introduced by the policy 710 can be measured by the height of the bin 712 or an area of the bin 712. The error introduced by the policy 720 can be measured by a sum of heights of the bins 713, 714, and 715 or a sum of areas of the bins 713, 714, and 715. In this way, the histogram generator 420 can select, from among the policies, a policy that introduces the minimum error. For example, from among the policies 710 and 720 as shown in FIG. 7B, the policy 710 can be selected.

FIG. 7C shows 6 bins 731, 732 . . . 736 that are adjusted from the bins 711, 712 . . . 716 as shown in FIG. 7A based on the policy 710 as shown in FIG. 7B. As shown in FIG. 7C, the bin 711 is adjusted to the bin 731; the bin 712 is adjusted to the bin 732; . . . the bin 716 is adjusted to the bin 736. For example, the bin 711 is adjusted to the sub-range [V_L, V1] without changing its height; the bin 712 is adjusted to the sub-range (V1, V2] without changing its height; . . . the bin 716 is adjusted to the sub-range (V5, V_U] without changing its height. Each of the bins 731, 732 . . . 736 has a same width, and thus the adjusted histogram can reflect densities of data points falling within different ranges better.

Alternatively, in some embodiments, the histogram generator 420 may adjust the first set of bins to a second set of bins without introducing an error, such that an evenness degree of widths of the second set of bins exceeds an evenness degree of widths of the first set of bins. That is, the second set of bins may not have a same width, but the variance of widths of the second set of bins is less than the variance of widths of the first set of bins.

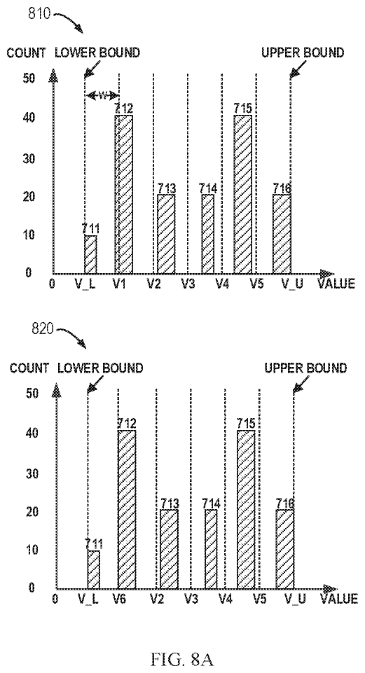

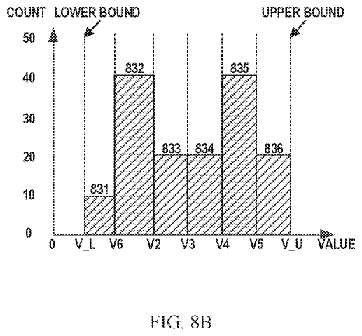

FIGS. 8A-8B depict another example of adjusting bins of a histogram according to an embodiment of the present invention. FIG. 8A shows a policy 810 for adjusting the bins 711, 712 . . . 716 as shown in FIG. 7A to a group of bins of a same width. As shown by the policy 810, for example, the lower bound of the bin 711 is V_L, which can be determined as the lower bound of the group of bins. The upper bound of the bin 716 is V_U, which can be determined as the upper bound of the group of bins. The range between V_L and V_U is divided into six sub-ranges, each of which has a width W. The six sub-ranges may correspond to the group of bins to which the bins 711, 712 . . . 716 can be adjusted. It can be seen that the bin 712 is overlapped with two sub-ranges [V_L, V1] and (V1, V2]. That means values of some data points in the bin 712 are greater than V1, while values of remaining data points in the bin 712 are less than V1. Regardless of whether the bin 712 is adjusted to the sub-range [V_L, V1] or (V1, V2], an error will be introduced.

In some embodiments, the histogram generator 420 may remove the overlap from the policy 810 by adjusting the two sub-ranges [V_L, V1] and (V1, V2] to [V_L, V6] and (V6. V2], respectively. V6 can be determined based on the lower bound of the bin 712. For example, V6 is equal to the value of the lower bound of the bin 712. As such, the policy 810 can be adjusted to a policy 820 as shown in FIG. 8A, where no overlap is existing. FIG. 8B shows six bins 831, 832 . . . 836 that are adjusted from the bins 711, 712 . . . 716 as shown in FIG. 7A based on the policy 820 as shown in FIG. 8A. For example, the bin 711 is adjusted to the bin 831; the bin 712 is adjusted to the bin 832; . . . the bin 716 is adjusted to the bin 836. Although the bins 831, 832 . . . 836 do not have a same width, the evenness degree of the bins 831, 832 . . . 836 exceeds the evenness degree of the bins 711, 712 . . . 716. Thus, the adjusted histogram can reflect densities of data points falling within different ranges better.

It can be seen that embodiments of the present invention provide a solution for histogram generation. Embodiments of the present invention enable an accurate histogram to be generated through only one data scan on the data points and thus is applicable to the streaming condition. Moreover, embodiments of the present invention can further improve the evenness degree of the bins of the generated histogram, so as to reflect densities of data points falling within different ranges better.

It should be noted that the processing of histogram generation according to embodiments of this invention could be implemented by computer system/server 12 of FIG. 1.

Programs described herein is identified based upon the application for which it is implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
acquiring, by one or more processors, a first set of bins for a histogram, wherein the first set of bins is generated based on a plurality of data points and comprises a predetermined number of bins;
in response to receiving a data point, determining, by the one or more processors, a bin closest to the data point from the first set of bins; and
in response to a distance between the data point and the bin not exceeding a threshold, merging, by the one or more processors, the data point into a target bin comprised in the first set of bins, wherein a width of the target bin after merging the data point is closest to an average width of the first set of bins before the merging.

2. The method of claim 1, further comprising:
in response to the distance between the data point and the bin exceeding the threshold, merging, by the one or more processors, two closest bins comprised in the first set of bins into one bin; and
generating, by the one or more processors, a new bin based on the data point.

3. The method of claim 1, wherein acquiring the first set of bins comprises:
in response to receiving a first data point having a different value from any existing data point comprised in the first set of bins and the number of existing bins not exceeding the predetermined number, generating, by the one or more processors, a first bin of the first set of bins based on the first data point.

4. The method of claim 1, wherein acquiring the first set of bins comprises:
in response to receiving a second data point having a same value as one of existing data points comprised in the first set of bins, merging, by the one or more processors, the second data point into a respective bin representing the one of the existing data points by incrementing a height of the respective bin.

5. The method of claim 1, wherein merging the data point into the target bin comprises:
in response to a value of the data point falling between upper and lower bounds of the target bin, merging, by the one or more processors, the data point into the target bin by incrementing a height of the target bin.

6. The method of claim 1, wherein merging the data point into the target bin comprises:
in response to a value of the data point being below a lower bound of the target bin,
determining, by the one or more processors, the value of the data point as a new lower bound of the target bin;
updating, by the one or more processors, the width of the target bin based on an upper bound and the new lower bound of the target bin; and
merging, by the one or more processors, the data point into the target bin by incrementing a height of the target bin.

7. The method of claim 1, wherein merging the data point into the target bin comprises:
in response to a value of the data point being above an upper bound of the target bin,
determining, by the one or more processors, the value of the data point as a new upper bound of the target bin;
updating, by the one or more processors, the width of the target bin based on the new upper bound and a lower bound of the target bin; and
merging, by the one or more processors, the data point into the target bin by incrementing a height of the target bin.

8. The method of claim 1, further comprising:
adjusting, by the one or more processors, the first set of bins to a second set of bins each with a same width.

9. The method of claim 1, further comprising:
adjusting, by the one or more processors, the first set of bins to a second set of bins, such that an evenness degree of widths of the second set of bins exceeds an evenness degree of widths of the first set of bins.

10. The method of claim 1, further comprising:
receiving, by the one or more processors, the data points in a cloud computing environment or a streaming environment.

11. The method of claim 1, wherein the distance between the data point and the bin is determined as a smaller one of the following: a first difference between the value of the data point and the upper bound of the bin and a second difference between the value of the data point and the lower bound of the bin.

12. A computer system comprising:
one or more computer processors;
one or more computer readable storage media;
program instructions stored on the computer readable storage media for execution by at least one of the one or more processors, the program instructions comprising:
program instructions to acquire a first set of bins for a histogram, wherein the first set of bins is generated based on a plurality of data points and comprises a predetermined number of bins;
in response to receiving a data point, program instructions to determine a bin closest to the data point from the first set of bins; and
in response to a distance between the data point and the bin not exceeding a threshold, program instructions to merge the data point into a target bin comprised in the first set of bins, wherein the width of the target bin after merging the data point is closest to an average width of the first set of bins before the merging.

13. The computer system of claim 12, further comprising:
in response to the distance between the data point and the bin exceeding the threshold,
program instructions to merge two closest bins comprised in the first set of bins into one bin; and
program instructions to generate a new bin based on the data point.

14. The computer system of claim 12, wherein the program instructions to acquire the first set of bins comprise:
in response to receiving a first data point having a different value from any existing data point comprised in the first set of bins and the number of existing bins not exceeding the predetermined number, program instructions to generate a first bin of the first set of bins based on the first data point.

15. The computer system of claim 12, wherein the program instructions to acquire the first set of bins comprise:
in response to receiving a second data point having a same value as one of existing data points comprised in the first set of bins, program instructions to merge the second data point into a respective bin representing the one of the existing data points by incrementing a height of the respective bin.

16. The computer system of claim 12, wherein the program instructions to merge the data point into the target bin comprise:
in response to a value of the data point falling between upper and lower bounds of the target bin, program instructions to merge the data point into the target bin by incrementing a height of the target bin.

17. The computer system of claim 12, wherein the program instructions to merge the data point into the target bin comprise:
in response to a value of the data point being below a lower bound of the target bin,
program instructions to determine the value of the data point as a new lower bound of the target bin;
program instructions to update the width of the target bin based on an upper bound and the new lower bound of the target bin; and
program instructions to merge the data point into the target bin by incrementing a height of the target bin.

18. The computer system of claim 12, wherein the program instructions to merge the data point into the target bin comprise:
in response to a value of the data point being above an upper bound of the target bin, program instructions to determine the value of the data point as a new upper bound of the target bin;
program instructions to update the width of the target bin based on the new upper bound and a lower bound of the target bin; and
program instructions to merge the data point into the target bin by incrementing a height of the target bin.

19. The computer system of claim 12, further comprising:
program instructions to adjust the first set of bins to a second set of bins each with a same width.

20. A computer program product comprising:
one or more computer readable storage media and program instructions stored on the one or more computer readable storage media, the program instructions comprising:
program instructions to acquire a first set of bins for a histogram, wherein the first set of bins is generated based on a plurality of data points and comprises a predetermined number of bins;
in response to receiving a data point, program instructions to determine a bin closest to the data point from the first set of bins; and
in response to a distance between the data point and the bin not exceeding a threshold, program instructions to merge the data point into a target bin comprised in the first set of bins, wherein a width of the target bin after merging the data point is closest to an average width of the first set of bins before the merging.
